(19) United States
(12) Patent Application Publication
(10) Pub. No.: US 2006/0273202 A1
(43) Pub. Date: Dec. 7, 2006

(54) Adjustable lawn sprinkler

(76) Inventor: Cheng-Wen Su, Changhwa City (TW)

Correspondence Address: BIRCH STEWART KOLASCH & BIRCH, PO BOX 747, FALLS CHURCH, VA, 22040-0747, US

(21) Appl. No.: 11/175,325

(22) Filed: Jul. 7, 2005

(30) Foreign Application Priority Data
May 13, 2005 (TW) 094115500

(51) Int. Cl. A62C 31/02

(52) U.S. Cl. 239/394; 239/273; 239/275; 239/279

(57) ABSTRACT

An adjustable lawn sprinkler with an adjustable rotating speed has a rotating base with an outlet and a rotatable disk. The rotatable disk rotatably mounts on the rotating base and has multiple nozzles with different sprinkling patterns rotatably mounted in the rotatable disk. By selecting aligning one of the multiple nozzles with the outlet on the rotating base, the sprinkling pattern of the adjustable lawn sprinkler is changeable. Moreover, by turning the aligned nozzle, the rotating speed of the adjustable lawn sprinkler can be adjusted.

### BACKGROUND OF THE INVENTION

1. Field of the Invention

The present invention relates to a lawn sprinkler, and more particularly to an adjustable lawn sprinkler that can conveniently adjust the pattern and speed of water sprayed from the sprinkler.

2. Description of Related Art

With reference to FIG. 8, one type of conventional sprinkler comprises a base (60) and a rotatable disk (70). The base (60) is placed on the ground and has a top (not numbered), a side inlet (not numbered) and an outlet (not shown). A hose (62) connected to an external water source is connected to the side inlet and supplies water to the base (60). The outlet is defined in the top of the base (60) and communicates with the side inlet.

The rotatable disk (70) is rotatably mounted on the base (60) and has a top and multiple nozzles (72) defined on the top. Each nozzle (72) sprays a different pattern and can be aligned selectively with the outlet on the base (60) so water sprays out through the selected nozzle (72). However, this type of conventional lawn sprinkler cannot rotate to spray water over a large area.

With reference to FIG. 9, a second type of conventional lawn sprinkler comprises a base (80) and multiple nozzles (90). The base (80) is a short cylinder, is attached rotatably to a hose and has a side surface and three water outlets (not shown) defined in the side surface. The nozzles (90) are rotatably mounted respectively on the water outlets. Each nozzle (90) has an inclined distal face (not numbered) and multiple holes (not numbered) so water sprays from the sprinkler through the holes and rotates the lawn sprinkler. Rotating the nozzle heads (90) on the side surface changes the direction water sprays from the lawn sprinkler. Water spraying from the nozzles (90) with even a small tangential component generate enough torsional force to rotate the base (80). Although this type of conventional lawn sprinkler rotates, water is only sprayed in a single mode and pattern. Performance of the second conventional sprinkler is ordinary.

To overcome the shortcomings, the present invention provides an adjustable lawn sprinkler to mitigate and obviate the aforementioned problems.

### SUMMARY OF THE INVENTION

The main objective of the present invention is to provide an adjustable lawn sprinkler that has multiple patterns and rotating speeds.

The adjustable lawn sprinkler in accordance with the present invention comprises a rotating base and a rotatable disk. The rotating base has an outlet. The rotatable disk is mounted rotatably on the rotating base and has multiple nozzle recesses and multiple nozzles. The nozzles have different patterns and are rotatably mounted respectively in the nozzle recesses.

By aligning a specific nozzle with the outlet on the rotating base, a specific sprinkling pattern is selected. Moreover, turning the nozzle in its nozzle recess changes the direction water is sprayed from the rotatable disk. This changes the tangential component of force applied to the rotating base and the speed of the adjustable lawn sprinkler. Other objects, advantages and novel features of the invention will become more apparent from the following detailed description when taken in conjunction with the accompanying drawings.

### BRIEF DESCRIPTION OF THE DRAWINGS

FIG. 1 is an exploded perspective top view of an adjustable lawn sprinkler in accordance with the present invention;

FIG. 2 is an exploded perspective bottom view of the adjustable lawn sprinkler in FIG. 1;

FIG. 3 is a cross-sectional side view of the adjustable sprinkler in FIG. 1;

FIG. 4A is an operational top view of the adjustable lawn sprinkler in FIG. 1 with the nozzles adjusted to spray water out radially from the adjustable lawn sprinkler;

FIG. 4B is an operational top view of the adjustable lawn sprinkler in FIG. 1 with the nozzles adjusted to spray water out tangentially from the adjustable lawn sprinkler;

FIG. 5 is a perspective view of another embodiment of the adjustable lawn sprinkler in accordance with the present invention;

FIG. 6 is an exploded bottom perspective view of another embodiment of the adjustable lawn sprinkler in accordance with the present invention;

FIG. 7 is a cross-sectional side view of another embodiment of the adjustable lawn sprinkler in accordance with the present invention;

FIG. 8 is a perspective view of a conventional lawn sprinkler in accordance with prior art; and

FIG. 9 is a perspective view of another conventional lawn sprinkler in accordance with prior art.

### DETAILED DESCRIPTION OF PREFERRED EMBODIMENT

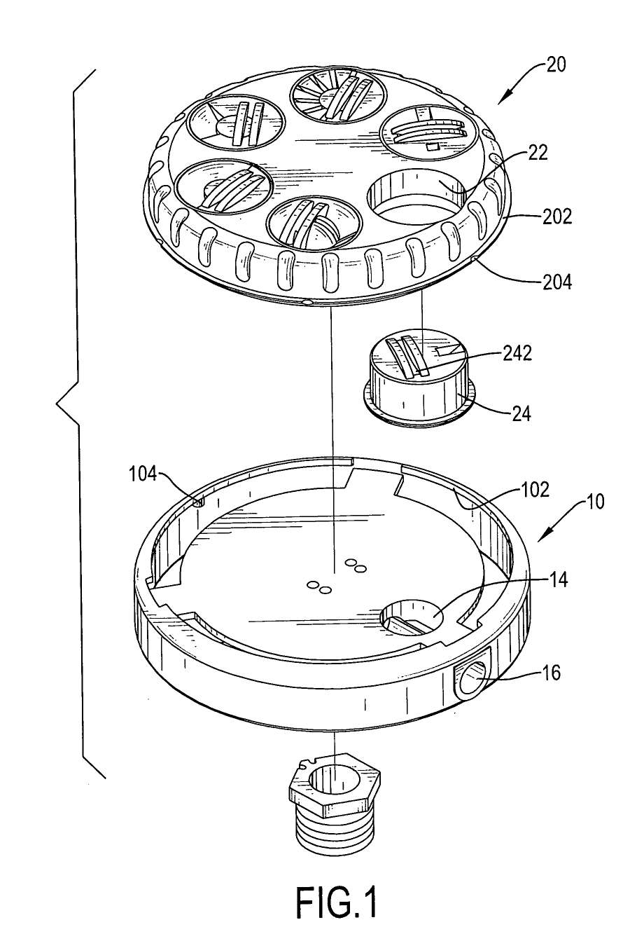

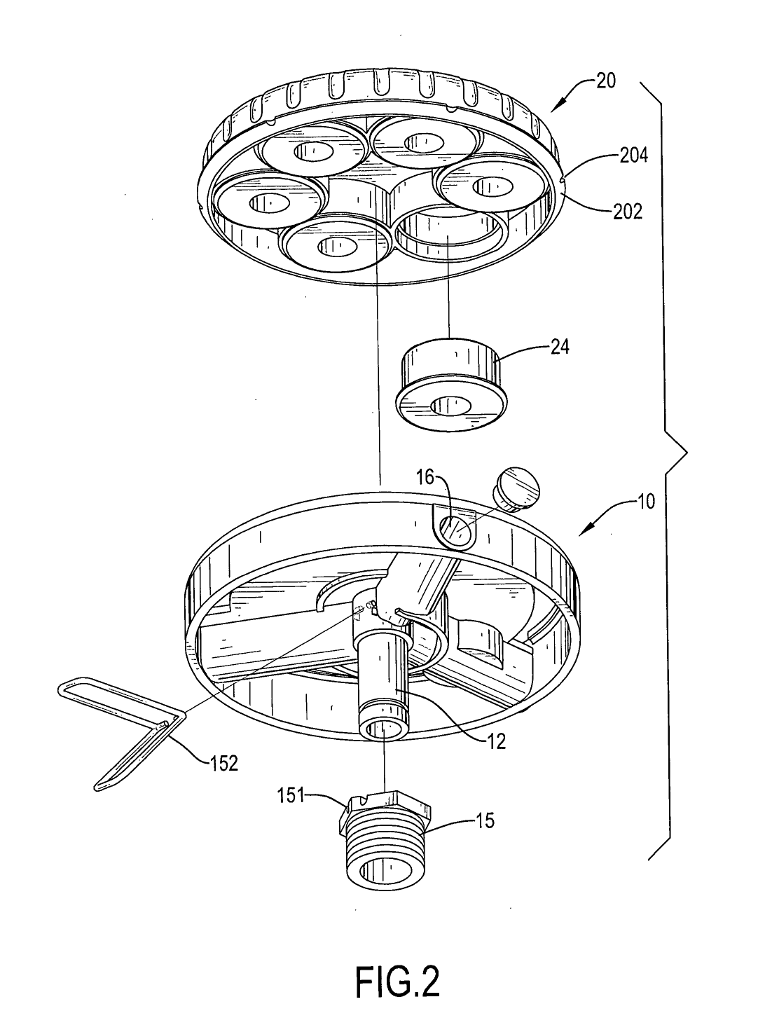

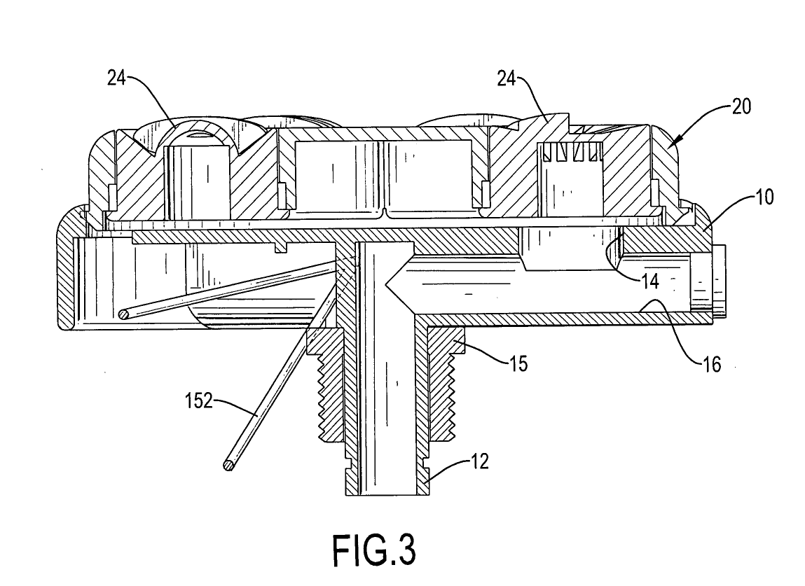

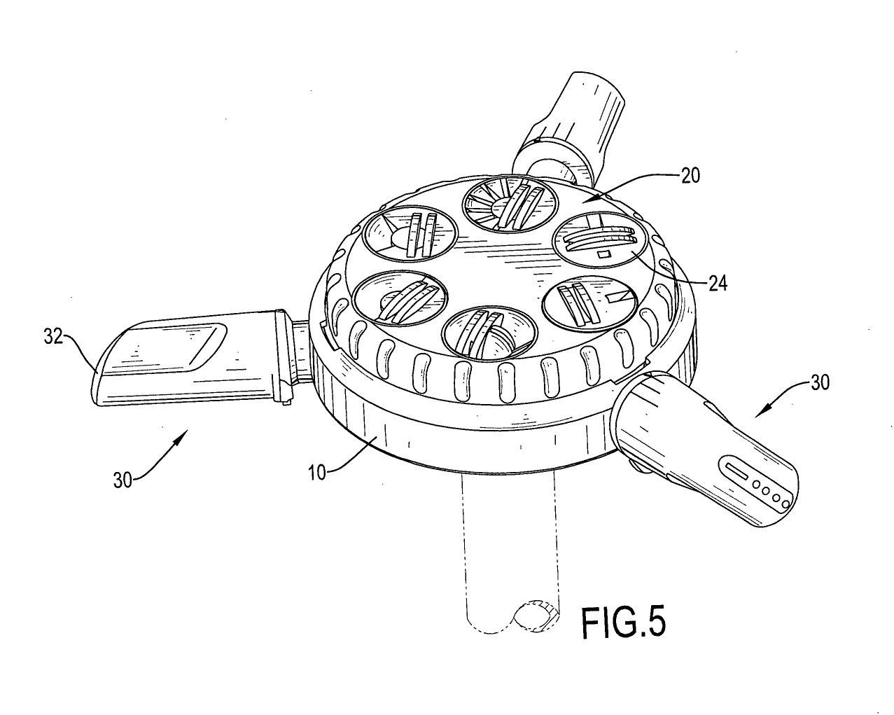

With reference to FIGS. 1 to 3 and 5, the adjustable lawn sprinkler in accordance with the present invention comprises a base (10), a rotatable disk (20) and one or more optional radial nozzles (30).

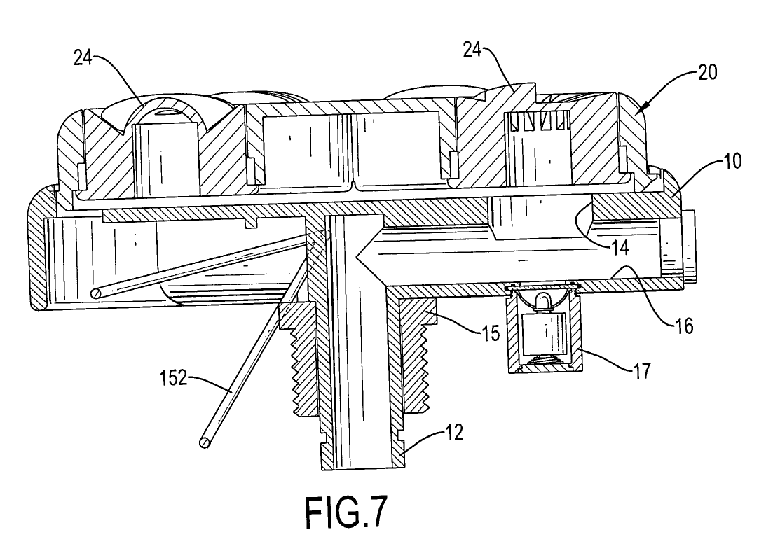

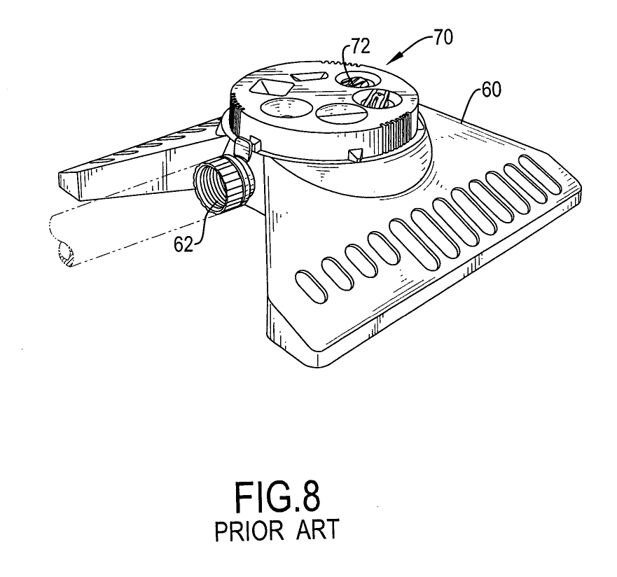

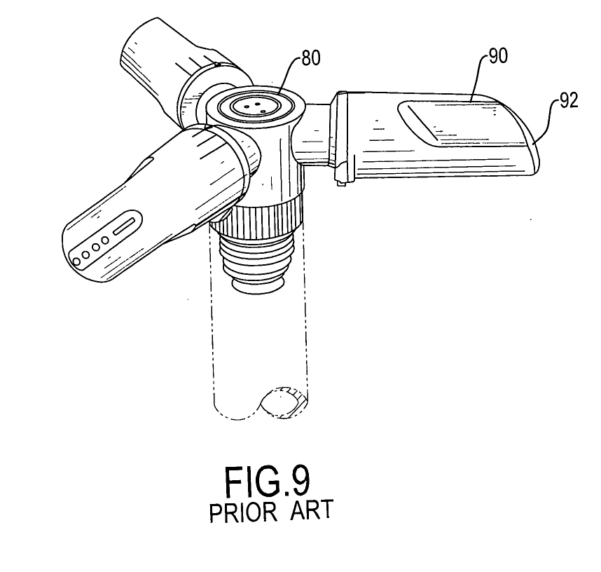

With further reference to FIG. 7, the base (10) is attached rotatably to a hose (not shown) and has a body, a lower rotary connector, a upper rotary connector, a main outlet (14), a channel, an optional lighting device (17), an optional positioning device and multiple optional auxiliary outlets (16).

The body is circular and has a center, an outer edge, a top face, a bottom face and a skirt. The bottom face has a center. The skirt is formed on and extends down from the outer edge.

The lower rotary connector may be implemented with a hollow shaft (12) attached to the center of the bottom face of the base (10) and attached rotatably to a hose.

The upper rotary connector may be implemented with an annular groove (102) and multiple bosses (104). The annular groove (102) is formed around the top face of the base (10) near the outer edge and has an inner face. The multiple bosses (104) are formed on the inner face of the annular groove (102).

The main outlet (14) is defined through the top face of the base (10).

The channel is formed on the bottom face of the base (10) between the hollow shaft (12) and the main outlet (14) to allow water to flow to the main outlet (14) from the hollow shaft (12).

The lighting device (17) is mounted under the base (10), is aligned with the main outlet (14) to light water sprayed from the adjustable lawn sprinkler and has a sensor. The sensor detects water flowing through the adjustable lawn sprinkler and turns on the lighting device (17).

The positioning device selectively keeps the base (10) from rotating and comprises a sleeve (15) and a clasp (152). The sleeve (15) is mounted securely in the hose and rotatably around the hollow shaft (12) and has a top, an outer surface, a notch (151) and an exterior thread. The notch (151) is defined in the top of the sleeve (15). The exterior thread is defined around the outer surface to attach the positioning device conveniently to a hose. The clasp (152) is attached pivotally to the hollow shaft (12), is rectangular, is bent to a V-shape and has two points and two mounting pins. The pins extend inward toward each other from the points of the clasp (152) and are attached pivotally to the hollow shaft (12) near the bottom face of the base (10). Thereby, the clasp (152) can be pivoted to engage the notch (151) in the sleeve (15) and keep the base (10) from rotating or pivoted against the bottom face to allow the base (10) to rotate.

The auxiliary outlets (16) are formed in the skirt of the base (10) and communicate with the main outlet (14).

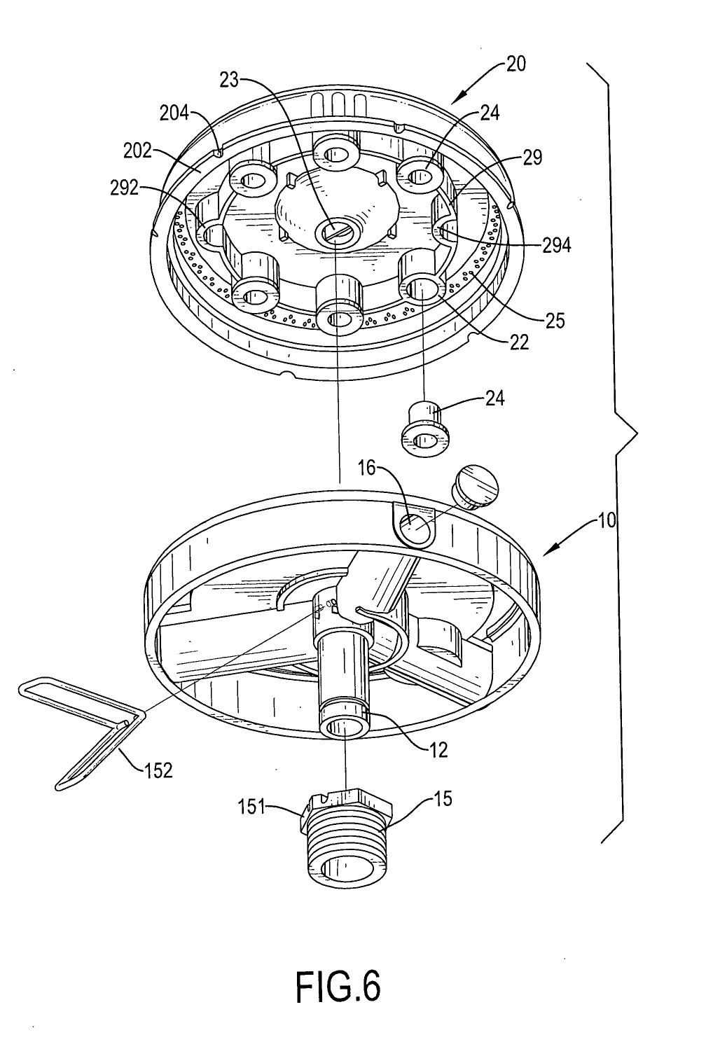

With further reference to FIG. 6, the rotatable disk (20) may be a round cover, is rotatably mounted on the base (10) and has a top face, a bottom face, a skirt, a rotary connector, multiple optional nozzle recesses (22), an optional central spray hole (23), multiple optional outlet holes (25), an optional annular dividing wall (29) and multiple nozzles (24).

The rotary connector connects rotatably to the upper rotary connector on the base (10) and may be implemented with an annular flange (202) and multiple detents (204). The annular flange (202) is formed around the bottom face of the rotatable disk (20), is mounted rotatably in the annular groove (102) in the base (10) and has an outer edge. The multiple detents (204) are defined in the outer edge of the annular flange (202), correspond to the bosses (104) and engage the bosses (104) on the base (10) so that the rotatable disk (20) can be held in a desired position relative to the base (10).

The nozzle recesses (22) are defined in the top face of the rotatable disk (20) in a circular arrangement, correspond to the detents (204) and bosses (104), selectively align with the main outlet (14) in the base (10) when the detents (204) engage the bosses (104) and may be tubular posts attached to the bottom face of the rotatable disk (20).

The central spray hole (23) is formed through the rotatably disk (20) to spray water up from the adjustable lawn sprinkler.

The outlet holes (25) are formed through the rotatable disk (20) between the nozzle recesses (22) and the skirt to provide a fine upward spray or mist and are evenly distributed around the rotatable disk (20).

The annular dividing wall (29) is formed on and extends down from the bottom face of the rotatable disk (20) in conjunction with the nozzle recesses (22) to form an inner area and an outer area and may have an outer semicylindrical partition (292) and an inner semicylindrical partition (294). The inner area communicates with the central spray hole (23). The outer area communicates with the outlet holes (25). The outer semicylindrical partition (292) is an outward curve in the annular dividing wall (29) that selectively corresponds to the main outlet (14) in the base (10) to direct water to the inner area to be sprayed from the central spray hole (23). The inner semicylindrical partition (294) is an inward curve in the annular dividing wall (29) that selectively corresponds to the main outlet (14) in the base (10) to direct water to the outer area to be sprayed from the small outlet holes (25).

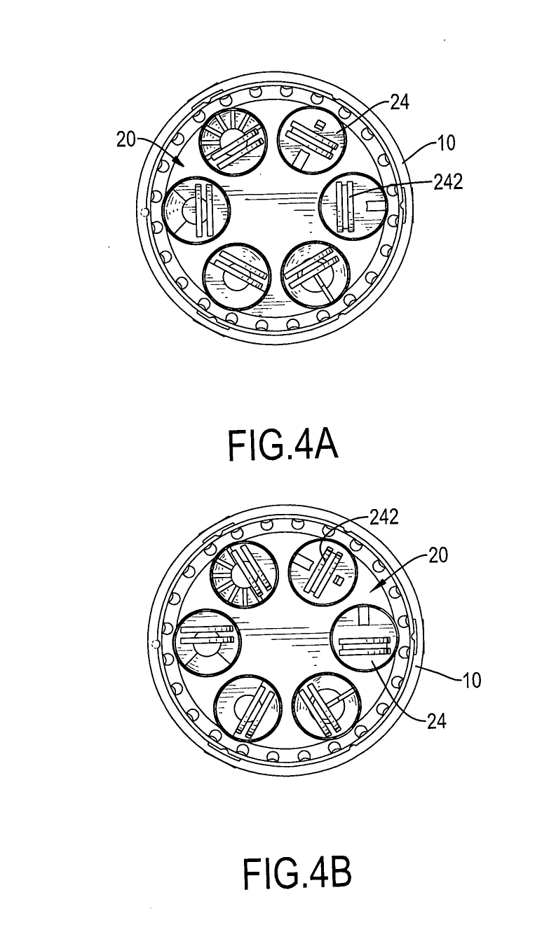

The nozzles (24) are mounted respectively in the nozzle recesses (22) and may be mounted securely or rotatably in the nozzle recesses (22). Each nozzle (24) has a top, at least one optional rib (242) and an outlet. The at least one rib (242) is formed on and protrudes up from the top of the nozzle (24) to rotate the nozzle (24) easily and change the direction in which water is sprayed from the nozzle (24). The outlets are formed in the tops respectively of the nozzles (24) and are different shapes to provide different spray patterns. With further reference to FIG. 4A, spot watering is accomplished by orienting the outlet of the nozzle (24) in a radial direction relative to the adjustable lawn sprinkler. 1 Consequently, no tangential component of the reactive force of water being sprayed from the nozzle (24) exists so the adjustable lawn sprinkler does not rotate. When the nozzle (24) aligned with the main outlet (14) is oriented to any direction other than a radial direction relative to the adjustable lawn sprinkler, a tangential component of the reactive force of the spaying water causes the adjustable lawn sprinkle to rotate, and a large area is sprayed. Orienting the outlet of the nozzle (24) farther from the radial direction causes a greater tangential component to be applied to the adjustable lawn sprinkler, and the adjustable lawn sprinkler rotates faster.

The radial nozzles (30) are rotatably mounted respectively in the auxiliary outlets (16). Each radial nozzle (30) has a distal end, an inclined face (32) and multiple holes. The inclined face (32) is defined at the distal end. The holes are defined on the inclined face (32). When the radial nozzles (30) are rotated to spray water at an angle such that the horizontal tangential component is greater, the rotating speed of the adjustable lawn sprinkler increases.

The adjustable sprinkler has the following advantages:

1. By rotating the rotatable disk (20) to align different nozzles (24) with the main outlet (14), water can be sprayed in different patterns, and the adjustable lawn sprinkler can perform various functions including heavy watering to misting in either selected spots over large areas.

2. Turning the nozzle (24) changes the direction water sprays from the base (10) and increases or decreases the rotating speed of the sprinkler.

Therefore, the adjustable sprinkler is versatile, practical and useful. Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An adjustable sprinkler comprising:
a rotating base having
a body;
a lower rotary connector;
an upper rotary connector; and
a main outlet; and
a rotatable disk rotatably mounted on the base and having
a top face;
a bottom face;
a skirt;
a rotary connector connecting rotatably to the upper rotary connector on the base; and
multiple nozzles mounted in the rotatable disk.

2. The adjustable sprinkler as claimed in claim 1, wherein
the body of the base is circular and has
an outer edge;
a top face;
a bottom face having a center; and
a skirt formed on and extends down from the outer edge;
the upper rotary connector is an annular groove formed around the top face of the body of the base;
the lower rotary connector is a hollow shaft attached to the center on the bottom face;
the main outlet is defined through the top face of the base; and
the rotary connector on the rotatable disk is an annular flange formed around the bottom face rotatably mounted in the annular groove in the base.

3. The adjustable sprinkler as claimed in claim 2, wherein
the annular groove has an inner face;
the annular flange has an outer edge;
the upper rotary connector on the base has multiple bosses formed on the inner face of the annular groove; and
the rotary connector on the rotatable disk has multiple detents formed in the outer edge of the annular flange to engage with the bosses on the inner face of the annular groove of the upper rotary connector.

4. The adjustable sprinkler as claimed in claim 2, wherein the base further has
multiple auxiliary outlets formed in the skirt of the base; and
multiple radial nozzles rotatably mounted respectively in the auxiliary outlets.

5. The adjustable sprinkler as claimed in claim 3, wherein the base further has
multiple auxiliary outlets formed on the skirt of the base; and
multiple radial nozzles rotatably mounted respectively in the auxiliary outlets.

6. The adjustable sprinkler as claimed in claim 2, wherein the adjustable sprinkler further has a positioning device comprising:
a sleeve mounted rotatably around the hollow shaft on the base and having
a top;
an outer surface;
a notch defined in the top of the sleeve; and
an exterior thread defined around the outer surface;
a clasp pivotally attached to the hollow shaft, being rectangular, being bent to a V-shape and having two points and two mounting pins formed respectively at and extending inward toward each other from the points of the clasp.

7. The adjustable sprinkler as claimed in claim 5, wherein the adjustable sprinkler further has a positioning device comprising:
a sleeve mounted rotatably around the hollow shaft on the base and having atop;
an outer surface,
a notch defined in the top of the sleeve; and
an exterior thread defined around the outer surface;
a clasp pivotally attached to the hollow shaft, being rectangular, being bent to a V-shape having two points and two mounting pins formed respectively at and extending inward toward each other from the points of the clasp.

8. The adjustable sprinkler as claimed in claim 7, wherein each nozzle has a top and at least one rib formed on protruding up from the top of the nozzle.

9. The adjustable sprinkler as claimed in claim 8, wherein the base further has a lighting device mounted under the base and aligned with the main outlet.

10. The adjustable sprinkler as claimed in claim 1, wherein
the rotatable disk is a round cover and further has
a central spray hole defined through the rotatable disk;
multiple outlet holes formed through the rotatable disk between the nozzle recesses and the skirt and evenly distributed around the rotatable disk; and
an annular dividing wall formed on and extending down from the bottom face of the rotatable disk in conjunction with the nozzle recesses to form an inner area communicating with the central spray hole and an outer area communicating with the outlet holes; and
the nozzle recesses are tubular posts and are attached on the bottom face of the rotatable disk respectively to hold the nozzles.

11. The adjustable sprinkler as claimed in claim 10, wherein
the annular dividing wall further has
an outer semicylindrical partition being an outward curve in the annular dividing wall that selectively corresponds to the main outlet in the base to direct water to the inner area; and
an inner semicylindrical partition being an inward curve in the annular dividing wall that selectively corresponds to the main outlet in the base to direct water to the outer area.

12. The adjustable sprinkler as claimed in claim 11, wherein the base further has a lighting device mounted under the base and aligned with the main outlet.

13. The adjustable sprinkler as claimed in claim 12, wherein the nozzles are integrally formed on the rotatable disk.
